(19) United States
(12) Patent Application Publication
(10) Pub. No.: US 2024/0191115 A1
(43) Pub. Date: Jun. 13, 2024

(54) SILICONE-BASED SEALANT AND METHODS OF FORMING THE SAME

(71) Applicant: SAINT-GOBAIN CERAMICS & PLASTICS, INC., Worcester, MA (US)

(72) Inventors: Shuai LIANG, Southborough, MA (US); Hua WANG, Northbridge, MA (US)

(21) Appl. No.: 18/538,624

(22) Filed: Dec. 13, 2023

Related U.S. Application Data
(60) Provisional application No. 63/387,201, filed on Dec. 13, 2022.

(51) Int. Cl. C09K 3/10

(52) U.S. Cl. CPC C09K 3/1018; C09K 2200/0685

(57) ABSTRACT

The subject application relates to a silicone-based sealant that may be formed from a two-part forming mixture. The two-part forming mixture may include a first component and a second component that chemically reacts with the first component upon combination. The first component of the two-part forming mixture may include an amino silicone component, a filler composition, and a silane component. The second component may include an aldehyde component.

### CROSS-REFERENCE TO RELATED APPLICATION(S)

This application claims priority under 35 U.S.C. § 119(c) to U.S. Provisional Application No. 63/387,201, entitled “SILICONE-BASED SEALANT AND METHODS OF FORMING THE SAME,” by Shuai LIANG et al., filed Dec. 13, 2022, which is assigned to the current assignee hereof and incorporated herein by reference in its entirety.

### FIELD OF THE DISCLOSURE

The present disclosure relates to a silicone-based sealant and methods of forming the same, more particularly, the present disclosure related to a silicone-based sealant formed from a two-part forming mixture and methods of forming the same.

### BACKGROUND

Sealants are widely used in applications of construction, transportation, electronics, and others. However, sealants often require dry conditions to solidify and cure. Such sealants are therefore undesirable for wet or underwater conditions. Accordingly, sealant formulations that can form and cure quickly in wet conditions are desired.

### SUMMARY

According to a first aspect, a silicone-based sealant may be formed from a two-part forming mixture. The two-part forming mixture may include a first component and a second component that chemically reacts with the first component upon combination. The first component of the two-part forming mixture may include an amino silicone component, a filler composition, and a silane component. The second component may include an aldehyde component.

According to another aspect, a two-part forming mixture may include a first component and a second component that chemically reacts with the first component upon combination to form a silicone-based sealant. The first component of the two-part forming mixture may include an amino silicone component, a filler composition, and a silane component. The second component may include an aldehyde component.

According to yet another aspect, a method of forming a silicone-based sealant may include providing a two-part forming mixture that may include a first component and a second component, and combining the first component and the second component where the second component chemically reacts with the first component to form the silicone-based sealant. The first component of the two-part forming mixture may include an amino silicone component, a filler composition, and a silane component. The second component may include an aldehyde component.

### BRIEF DESCRIPTION OF THE DRAWINGS

Embodiments are illustrated by way of example and are not limited to the accompanying figures.

FIG. 1 includes a diagram showing a silicone-based sealant forming method 100 according to embodiments described herein.

FIG. 2 includes a plot of contents of a first component vs. gel time of two-part forming mixture samples according to embodiments described herein.

FIG. 3 includes a plot of contents of an amino silicone vs. viscosity at frequency 0.1 S⁻¹ of two-part forming mixture samples according to embodiments described herein.

FIG. 4 includes a plot of contents of an amino silicone vs. viscosity at frequency 1 S⁻¹ of two-part forming mixture samples according to embodiments described herein.

FIG. 5 includes a formula of pendant amino silicone.

FIG. 6 includes a formula of telechelic amino silicone.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a silicone-based sealant formed from a two-part forming mixture and methods of forming the same. More particularly, embodiments described herein are directed to a silicone-based sealant formed from a two-part forming mixture that can be formed when submerged in water and is generally water resilient, and methods of forming the same.

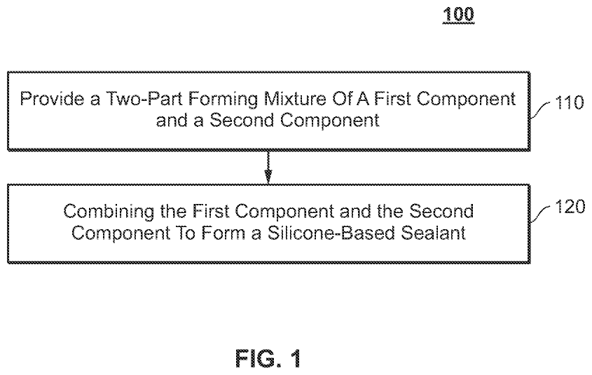

For purposes of illustration, FIG. 1 includes a diagram showing a silicone-based sealant forming method 100 according to particular embodiments described herein. The silicone-based sealant forming method 100 may include a first step 110 of providing a two-part forming mixture that may include a first component and a second component, and a second step 120 of combining the first component and the second component where the second component chemically reacts with the first component to form the silicone-based sealant.

Referring to the first step 110, according to certain embodiments, the first component of the two-part forming mixture may include an amino silicone component, a filler composition, and a silane component. According to still other embodiments, the second component may include an aldehyde component.

According to certain embodiments, the two-part forming mixture may include a particular content of the first component. For example, the two-part forming mixture may include a first component content of at least about 60 wt. % for a total weight of the two-part forming mixture, such as, at least about 62 wt. % or at least about 64 wt. % or at least about 66 wt. % or at least about 68 wt. % or at least about 70 wt. % or at least about 72 wt. % or at least about 74 wt. % or at least about 76 wt. % or at least about 78 wt. % or even at least about 80 wt. %. According to still other embodiments, the two-part forming mixture may include first component content of not greater than about 95 wt. % for a total weight of the two-part forming mixture, such as, not greater than about 94 wt. % or not greater than about 93 wt. % or not greater than about 92 wt. % or not greater than about 91 wt. % or not greater than about 90 wt. % or not greater than about 89 wt. % or not greater than about 88 wt. % or not greater than about 87 wt. % or not greater than about 86 wt. % or even not greater than about 85 wt. %. It will be appreciated that the content of the first component in the two-part forming mixture may be within a range between any of the minimum and maximum values noted above. It will be further appreciated that the content of the first component in the two-part forming mixture may be any value between any of the minimum and maximum values noted above.

According to still other embodiments, the two-part forming mixture may include a particular content of the second component. For example, the two-part forming mixture may include a second component content of at least about 5 wt. % for a total weight of the two-part forming mixture, such as, at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %. According to still other embodiments, the two-part forming mixture may include second component content of not greater than about 40 wt. % for a total weight of the two-part forming mixture, such as, not greater than about 38 wt. % or not greater than about 35 wt. % or not greater than about 32 wt. % or not greater than about 30 wt. % or not greater than about 28 wt. % or not greater than about 25 wt. % or not greater than about 22 wt. % or even not greater than about 20 wt. %. It will be appreciated that the content of the second component in the two-part forming mixture may be within a range between any of the minimum and maximum values noted above. It will be further appreciated that the content of the second component in the two-part forming mixture may be any value between any of the minimum and maximum values noted above.

According to yet other embodiments, the first component may have a particular viscosity as measured at 25° C. using a Brookfield LV #2 spindle operating at 12 RPM. For example, the viscosity of the first component may be at least about 6,000 cps, such as at least about 6,500 cps or at least about 7,000 cps or at least about 7,500 cps or at least about 8,000 cps or at least about 8,500 cps or at least about 9,000 cps or even at least about 9,500 cps. According to still other embodiments, the viscosity of the first component may be not greater than about 40,000 cps, such as not greater than about 38,000 cps or not greater than about 36,000 cps or not greater than about 34,000 cps or not greater than about 32,000 cps or not greater than about 30,000 cps or not greater than about 28,000 cps or even not greater than about 26,000 cps. It will be appreciated that the viscosity of the first component in the two-part forming mixture may be within a range between any of the minimum and maximum values noted above. It will be further appreciated that the viscosity of the first component in the two-part forming mixture may be any value between any of the minimum and maximum values noted above.

According to still other embodiments, the second component may have a particular viscosity as measured at 25° C. using a Brookfield LV #2 spindle operating at 12 RPM. For example, the viscosity of the second component may be at least about 1,000 cps or at least about 1,500 cps or at least about 2,000 cps or at least about 2,500 cps or at least about 3,000 cps or at least about 3,500 cps. According to still other embodiments, the viscosity of the second component may be not greater than about 20,000 cps or not greater than about 18,000 cps or not greater than about 16,000 cps or not greater than about 14,000 cps or not greater than about 12,000 cps. It will be appreciated that the viscosity of the second component in the two-part forming mixture may be within a range between any of the minimum and maximum values noted above. It will be further appreciated that the viscosity of the second component in the two-part forming mixture may be any value between any of the minimum and maximum values noted above.

According to still other embodiments, the amino silicone component of the first component may include particular materials. For example, the amino silicone component may include aminopropyl-terminated polydimethylsiloxanes, aminopropylmethylsiloxane-dimethylsiloxane copolymers, aminocthylaminoproplymethoxysiloxane dimethylsiloxane copolymers with branch structures or any combination thereof.

According to still other embodiments, the amino silicone component of the first component may have a particular average molecular weight. For example, the amino silicone component of the first component may have an average molecular weight of at least about 850 g/mol, such as, at least about 1,000 g/mol or at least about 2,000 g/mol or at least about 3,000 g/mol or at least about 4,000 g/mol or at least about 5,000 g/mol or at least about 10,000 g/mol or at least about 15,000 g/mol or at least about 20,000 g/mol or even at least about 25,000 g/mol. According to still other embodiments, the amino silicone component of the first component may have an average molecular weight of not greater than about 50,000 g/mol, such as, not greater than about 45,000 g/mol or even not greater than about 40,000 g/mol. It will be appreciated that the average molecular weight of the amino silicone component of the first component may be within a range between any of the minimum and maximum values noted above. It will be further appreciated that the average molecular weight of amino silicone component of the first component may be any value between any of the minimum and maximum values noted above.

According to certain embodiments, the first component may include a particular content of amino silicone component. For example, the first component may include an amino silicone component content of at least about 40 wt. % for a total weight of the first component, such as at least about 41 wt. % or at least about 42 wt. % or at least about 43 wt. % or at least about 44 wt. % or at least about 45 wt. % or at least about 46 wt. % or at least about 47 wt. % or at least about 48 wt. % or at least about 49 wt. % or even at least about 50 wt. %. According to still other embodiments, the first component may include an amino silicone component content of not greater than about 70 wt. % for a total weight of the first component, such as not greater than about 69 wt. % or not greater than about 68 wt. % or not greater than about 67 wt. % or not greater than about 66 wt. % or not greater than about 65 wt. % or not greater than about 64 wt. % or not greater than about 63 wt. % or not greater than about 62 wt. % or even not greater than about 61 wt. %. It will be appreciated that the content of the amino silicone component in the first component may be within a range between any of the minimum and maximum values noted above. It will be further appreciated that the content of the amino silicone component in the first component may be any value between any of the minimum and maximum values noted above.

According to certain embodiments, the amino silicone component may have a particular viscosity as measured at 25° C. using a Brookfield LV #2 spindle operating at 12 RPM. For example, the amino silicone component viscosity may be at least about 10 cps, such as at least about 25 cps or at least about 50 cps or at least about 75 cps or at least about 100 cps or at least about 200 cps or at least about 300 cps or even at least about 400 cps. According to still other embodiments, the amino silicone component viscosity may be not greater than about 6,000 cps, such as not greater than about 5,500 cps or not greater than about 5,000 cps or not greater than about 4,500 cps or not greater than about 4,000 cps or not greater than about 3,500 cps or even not greater than about 3,000 cps. It will be appreciated that the viscosity of the amino silicone component in the first component may be within a range between any of the minimum and maximum values noted above. It will be further appreciated that the viscosity of the amino silicone component in the first component may be any value between any of the minimum and maximum values noted above.

According to yet other embodiments, the amino silicone component may have a pendant amino position. According to yet other embodiments, the amino silicone component may have a terminal amino position.

According to still other embodiments, the amino silicone component may include a particular amino content. For example, the amino silicone component may include an amino content of at least about 0.05 wt. % for a total weight of the amino silicone component, such as, at least about 0.1 wt. % or at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 5.0 wt. % or at least about 7.5 wt. % or at least about 10.0 wt. % or at least about 12.5 wt. % or even at least about 15.0 wt. %. According to still other embodiments, the amino silicone component may include an amino content of not greater than about 25.0 wt. % for a total weight of the amino silicone component, such as, not greater than about 24.0 wt. % or not greater than about 23.0 wt. % or not greater than about 22.0 wt. % or not greater than about 21.0 wt. % or not greater than about 20.0 wt. % or not greater than about 19.0 wt. % or not greater than about 18.0 wt. % or even not greater than about 17.0 wt. %. It will be appreciated that the amino silicone component may include an amino content within a range between any of the minimum and maximum values noted above. It will be further appreciated that the amino silicone component may include an amino content may be any value between any of the minimum and maximum values noted above.

According to certain embodiments, the amino silicone component of the first component may include a short chain amino silicone and a long chain amino silicone.

According to still other embodiments, the short chain amino silicone of the first component may include particular materials. For example, the short chain amino silicone may include aminopropyl-terminated polydimethylsiloxanes, aminopropylmethylsiloxane-dimethylsiloxane copolymers, aminocthylaminoproplymethoxysiloxane dimethylsiloxane copolymers with branch structures or any combination thereof.

According to still other embodiments, the amino silicone component of the first component may have a particular average molecular weight. For example, the amino silicone component of the first component may have an average molecular weight of at least about 850 g/mol, such as, at least about 1,000 g/mol or at least about 2,000 g/mol or at least about 3,000 g/mol or at least about 4,000 g/mol or at least about 5,000 g/mol or at least about 10,000 g/mol or at least about 15,000 g/mol or at least about 20,000 g/mol or even at least about 25,000 g/mol. According to still other embodiments, the amino silicone component of the first component may have an average molecular weight of not greater than about 50,000 g/mol, such as, not greater than about 45,000 g/mol or even not greater than about 40,000 g/mol. It will be appreciated that the average molecular weight of the amino silicone component of the first component may be within a range between any of the minimum and maximum values noted above. It will be further appreciated that the average molecular weight of amino silicone component of the first component may be any value between any of the minimum and maximum values noted above.

According to certain embodiments, the first component may include a particular content of short chain amino silicone. For example, the first component may include a short chain amino silicone content of at least about 40 wt. % for a total weight of the first component, such as at least about 41 wt. % or at least about 42 wt. % or at least about 43 wt. % or at least about 44 wt. % or at least about 45 wt. % or at least about 46 wt. % or at least about 47 wt. % or at least about 48 wt. % or at least about 49 wt. % or even at least about 50 wt. %. According to still other embodiments, the first component may include a short chain amino silicone content of not greater than about 60 wt. % for a total weight of the first component, such as not greater than about 59 wt. % or not greater than about 58 wt. % or not greater than about 57 wt. % or not greater than about 56 wt. % or not greater than about 55 wt. % or not greater than about 54 wt. % or not greater than about 53 wt. % or not greater than about 52 wt. % or even not greater than about 51 wt. %. It will be appreciated that the content of the short chain amino silicone in the first component may be within a range between any of the minimum and maximum values noted above. It will be further appreciated that the content of the short chain amino silicone in the first component may be any value between any of the minimum and maximum values noted above.

According to certain embodiments, the short chain amino silicone may have a particular viscosity as measured at 25° ° C. using a Brookfield LV #2 spindle operating at 12 RPM. For example, the short chain amino silicone viscosity may be at least about 10 cps, such as at least about 25 cps or at least about 50 cps or at least about 75 cps or at least about 100 cps or at least about 200 cps or at least about 300 cps or even at least about 400 cps. According to still other embodiments, the short chain amino silicone viscosity may be not greater than about 800 cps, such as not greater than about 775 cps or not greater than about 750 cps or not greater than about 725 cps or not greater than about 700 cps or not greater than about 675 cps or not greater than about 650 cps or not greater than about 625 cps or even not greater than about 600 cps. It will be appreciated that the viscosity of the short chain amino silicone in the first component may be within a range between any of the minimum and maximum values noted above. It will be further appreciated that the viscosity of the short chain amino silicone in the first component may be any value between any of the minimum and maximum values noted above.

According to yet other embodiments, the short chain amino silicone may have a pendant amino position. According to yet other embodiments, the short chain amino silicone may have a terminal amino position.

According to still other embodiments, the short chain amino silicone may include a particular amino content. For example, the short chain amino silicone may include an amino content of at least about 2.0 wt. % for a total weight of the short chain amino silicone, such as, at least about 3.0 wt. % or at least about 4.0 wt. % or at least about 5.0 wt. % or at least about 6.0 wt. % or at least about 7.0 wt. % or at least about 8.0 wt. % or at least about 9.0 wt. % or at least about 10.0 wt. % or at least about 11.0 wt. % or at least about 12.0 wt. % or at least about 13.0 wt. % or at least about 14.0 wt. % or even at least about 15.0 wt. %. According to still other embodiments, the short chain amino silicone may include an amino content of not greater than about 25.0 wt. % for a total weight of the short chain amino silicone, such as, not greater than about 24.0 wt. % or not greater than about 23.0 wt. % or not greater than about 22.0 wt. % or not greater than about 21.0 wt. % or not greater than about 20.0 wt. % or not greater than about 19.0 wt. % or not greater than about 18.0 wt. % or even not greater than about 17.0 wt. %. It will be appreciated that the short chain amino silicone may include an amino content within a range between any of the minimum and maximum values noted above. It will be further appreciated that the short chain amino silicone may include an amino content may be any value between any of the minimum and maximum values noted above.

According to still other embodiments, the long chain amino silicone of the first component may include particular materials. For example, the long chain amino silicone may include particular materials. For example, the long chain amino silicone may include aminopropyl-terminated polydimethylsiloxanes, aminopropylmethylsiloxane-dimethylsiloxane copolymers, aminocthylaminoproplymethoxysiloxane dimethylsiloxane copolymers with branch structures or any combination thereof.

According to certain embodiments, the first component may include a particular content of long chain amino silicone. For example, the first component may include a long chain amino silicone content of at least about 10 wt. % for a total weight of the first component, such as at least about 11 wt. % or at least about 12 wt. % or at least about 13 wt. % or at least about 14 wt. % or even at least about 15 wt. %. According to still other embodiments, the first component may include a long chain amino silicone content of not greater than about 20 wt. % for a total weight of the first component, such as not greater than about 19 wt. % or not greater than about 18 wt. % or not greater than about 17 wt. % or even not greater than about 16 wt. %. It will be appreciated that the content of the long chain amino silicone in the first component may be within a range between any of the minimum and maximum values noted above. It will be further appreciated that the content of the long chain amino silicone in the first component may be any value between any of the minimum and maximum values noted above.

According to certain embodiments, the long chain amino silicone may have a particular viscosity as measured at 25° C. using a Brookfield LV #2 spindle operating at 12 RPM. For example, the long chain amino silicone viscosity may be at least about 800 cps, such as at least about 850 cps or at least about 900 cps or at least about 950 cps or at least about 1,000 cps or at least about 1,500 cps or at least about 2,000 cps or at least about 2,500 cps or even at least about 3,000 cps. According to still other embodiments, the long chain amino silicone viscosity may be not greater than about 6,000 cps, such as not greater than about 5,500 cps or not greater than about 5,000 cps or not greater than about 4,500 cps or not greater than about 4,000 cps or not greater than about 3,500 cps or even not greater than about 3,000 cps. It will be appreciated that the viscosity of the long chain amino silicone in the first component may be within a range between any of the minimum and maximum values noted above. It will be further appreciated that the viscosity of the long chain amino silicone in the first component may be any value between any of the minimum and maximum values noted above.

According to yet other embodiments, the long chain amino silicone may have a pendant amino position. According to yet other embodiments, the long chain amino silicone may have a terminal amino position.

According to still other embodiments, the long chain amino silicone may include a particular amino content. For example, the long chain amino silicone may include an amino content of at least about 0.05 wt. % for a total weight of the long chain amino silicone, such as, at least about 0.06 wt. % or at least about 0.07 wt. % or even at least about 0.08 wt. %. According to still other embodiments, the long chain amino silicone may include an amino content of not greater than about 0.15 wt. % for a total weight of the long chain amino silicone, such as, not greater than about 0.14 wt. % or not greater than about 0.13 wt. % or not greater than about 0.12 wt. % or not greater than about 0.11 wt. % or even not greater than about 0.11 wt. %. It will be appreciated that the long chain amino silicone may include an amino content within a range between any of the minimum and maximum values noted above. It will be further appreciated that the long chain amino silicone may include an amino content may be any value between any of the minimum and maximum values noted above.

According to still other embodiments, the filler composition of the first component may include particular materials. For example, the filler composition may include silica. According to still other embodiments, the filler composition of the first component may include fumed silica. According to still other embodiments, the filler composition of the first component may include precipitate silica. According to still other embodiments, the filler composition of the first component may include silicates, such as mica, or wollastonite. According to still other embodiments, the filler composition of the first component may include metal oxides, such as aluminum oxide, titanium dioxide, magnesium oxide, ferric oxide, beryllium oxide, chromium oxide, or zinc oxide. According to still other embodiments, the filler composition of the first component may include metal carbonates, such as calcium carbonate.

According to certain embodiments, the first component may include a particular content of filler composition. For example, the first component may include a filler composition content of at least about 25 wt. % for a total weight of the first component, such as at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or even at least about 35 wt. %. According to still other embodiments, the first component may include a filler composition content of not greater than about 45 wt. % for a total weight of the first component, such as not greater than about 44 wt. % or not greater than about 43 wt. % or not greater than about 42 wt. % or not greater than about 41 wt. % or not greater than about 40 wt. % or not greater than about 39 wt. % or not greater than about 38 wt. % or not greater than about 37 wt. % or even not greater than about 36 wt. %. It will be appreciated that the content of the filler composition in the first component may be within a range between any of the minimum and maximum values noted above. It will be further appreciated that the content of the filler composition in the first component may be any value between any of the minimum and maximum values noted above.

According to still other embodiments, the filler composition of the first component may include a silica based filler component and a calcium based filler component.

According to still other embodiments, the silica based filler component of the first component may include particular materials. For example, the silica based filler component may include natural silica, such as crystalline silica, ground crystalline silica, or diatomaceous silica. According to still other embodiments, the silica based filler component may include synthetic silica, such as fused silica, silica gel, pyrogenic silica, or precipitated silica.

According to certain embodiments, the first component may include a particular content of silica based filler component. For example, the first component may include a silica based filler component content of at least about 15 wt. % for a total weight of the first component, such as at least about 16 wt. % or at least about 17 wt. % or at least about 18 wt. % or at least about 19 wt. % or at least about 20 wt. % or at least about 21 wt. % or at least about 22 wt. % or at least about 23 wt. % or at least about 24 wt. % or even at least about 25 wt. %. According to still other embodiments, the first component may include a silica based filler component content of not greater than about 35 wt. % for a total weight of the first component, such as not greater than about 34 wt. % or not greater than about 33 wt. % or not greater than about 32 wt. % or not greater than about 31 wt. % or not greater than about 30 wt. % or not greater than about 29 wt. % or not greater than about 28 wt. % or not greater than about 27 wt. % or even not greater than about 26 wt. %. It will be appreciated that the content of the silica based filler component in the first component may be within a range between any of the minimum and maximum values noted above. It will be further appreciated that the content of the silica based filler component in the first component may be any value between any of the minimum and maximum values noted above.

According to still other embodiments, the calcium based filler component of the first component may include particular materials. For example, the calcium based filler component may include ground calcium carbonate. According to still other embodiments, the calcium based filler component may include synthesized calcium carbonate.

According to certain embodiments, the first component may include a particular content of calcium based filler component. For example, the first component may include a calcium based filler component content of at least about 5 wt. % for a total weight of the first component, such as at least about 6 wt. % or at least about 7 wt. % or at least about 8 wt. % or at least about 9 wt. % or even at least about 10 wt. %. According to still other embodiments, the first component may include a calcium based filler component content of not greater than about 15 wt. % for a total weight of the first component, such as not greater than about 14 wt. % or not greater than about 13 wt. % or not greater than about 12 wt. % or even not greater than about 11 wt. %. It will be appreciated that the content of the calcium based filler component in the first component may be within a range between any of the minimum and maximum values noted above. It will be further appreciated that the content of the calcium based filler component in the first component may be any value between any of the minimum and maximum values noted above.

According to still other embodiments, the silane component of the first component may include particular materials. For example, the silane component may include octyltrimethoxysilane, 3-Glycidyloxypropyl(dimethoxy)-methylsilane, 3-Glycidyloxypropyltrimethoxysilane, Diethoxy(3-glycidyloxypropyl)-methylsilane, Triethoxy(3-glycidyloxypropyl)-silane, [8-(Glycidyloxy)-n-octyl]-trimethoxysilane, methacryloxypropyl trimethoxysilane, vinyl trimethoxysilane, tetraethoxysilane, 3-Aminopropyltrimethoxysilane, 3-Aminopropyldimethoxymethylsilane, 3-Aminopropyldiethoxymethylsilane, 3-Aminopropyltriethoxysilane, 3-(2-Aminocthylamino)-propyldimethoxymethylsilane, 3-(2-Aminocthylamino)-propyltrimethoxysilane, 3-(2-Aminocthylamino)-propyltriethoxysilane, [3-(6-Aminohexylamino)-propyl]trimethoxysilane, Trimethoxy[3-(phenylamino)-propyl]silane, Bis[3-(trimethoxysilyl)-propyl]amine, partial condensation products thereof, or any combination thereof.

According to certain embodiments, the first component may include a particular content of silane component. For example, the first component may include a silane component content of at least about 0.5 wt. % for a total weight of the first component, such as at least about 0.6 wt. % or at least about 0.7 wt. % or at least about 0.8 wt. % or at least about 0.9 wt. % or even at least about 1.0 wt. %. According to still other embodiments, the first component may include a silane component content of not greater than about 5.0 wt. % for a total weight of the first component, such as not greater than about 4.8 wt. % or not greater than about 4.5 wt. % or not greater than about 4.3 wt. % or even not greater than about 4.0 wt. %. It will be appreciated that the content of the silane component in the first component may be within a range between any of the minimum and maximum values noted above. It will be further appreciated that the content of the silane component in the first component may be any value between any of the minimum and maximum values noted above.

According to still other embodiments, the aldehyde component of the second component may include particular materials. For example, the aldehyde component may include adipaldehyde, glutaraldehyde, oxaldehyde, formaldehyde, butanedial, 2,5-Thiophenedicarboxaldehyde, terephthalaldehyde, or any combination thereof.

According to certain embodiments, the second component may include a particular content of aldehyde component. For example, the second component may include an aldehyde component content of at least about 5 wt. % for a total weight of the second component, such as at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %. According to still other embodiments, the second component may include an aldehyde component content of not greater than about 50 wt. % for a total weight of the second component, such as not greater than about 48 wt. % or not greater than about 45 wt. % or not greater than about 43 wt. % or not greater than about 40 wt. % or not greater than about 38 wt. % or not greater than about 35 wt. % or not greater than about 33 wt. % or not greater than about 30 wt. % or even not greater than about 25 wt. %. It will be appreciated that the content of the aldehyde component in the second component may be within a range between any of the minimum and maximum values noted above. It will be further appreciated that the content of the aldehyde component in the second component may be any value between any of the minimum and maximum values noted above.

According to still other embodiments, the second component may further include a filler composition.

According to still other embodiments, the filler composition of the second component may include particular materials. For example, the filler composition may include silica. According to still other embodiments, the filler composition of the second component may include fumed silica. According to still other embodiments, the filler composition of the second component may include precipitate silica. According to still other embodiments, the filler composition of the second component may include silicates, such as mica, or wollastonite. According to still other embodiments, the filler composition of the second component may include metal oxides, such as aluminum oxide, titanium dioxide, magnesium oxide, ferric oxide, beryllium oxide, chromium oxide, or zinc oxide. According to still other embodiments, the filler composition of the second component may include metal carbonates, such as calcium carbonate.

According to certain embodiments, the second component may include a particular content of filler composition. For example, the second component may include a filler composition content of at least about 5 wt. % for a total weight of the second component, such as at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %. According to still other embodiments, the second component may include a filler composition content of not greater than about 50 wt. % for a total weight of the second component, such as not greater than about 48 wt. % or not greater than about 45 wt. % or not greater than about 43 wt. % or not greater than about 40 wt. % or not greater than about 38 wt. % or not greater than about 35 wt. % or not greater than about 33 wt. % or not greater than about 30 wt. % or even not greater than about 25 wt. %. It will be appreciated that the content of the filler composition in the second component may be within a range between any of the minimum and maximum values noted above. It will be further appreciated that the content of the filler composition in the second component may be any value between any of the minimum and maximum values noted above.

According to still other embodiments, the filler composition of the second component may include a silica based filler component and a calcium based filler component.

According to still other embodiments, the silica based filler component of the second component may include particular materials. For example, the silica based filler component may include natural silica, such as crystalline silica, ground crystalline silica, or diatomaceous silica. According to still other embodiments, the silica based filler component may include synthetic silica, such as fused silica, silica gel, pyrogenic silica, or precipitated silica.

According to certain embodiments, the second component may include a particular content of silica based filler component. For example, the second component may include a silica based filler component content of at least about 5 wt. % for a total weight of the second component, such as at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %. According to still other embodiments, the second component may include a silica based filler component content of not greater than about 50 wt. % for a total weight of the second component, such as not greater than about 48 wt. % or not greater than about 45 wt. % or not greater than about 43 wt. % or not greater than about 40 wt. % or not greater than about 38 wt. % or not greater than about 35 wt. % or not greater than about 33 wt. % or not greater than about 30 wt. % or even not greater than about 25 wt. %. It will be appreciated that the content of the silica based filler component in the second component may be within a range between any of the minimum and maximum values noted above. It will be further appreciated that the content of the silica based filler component in the second component may be any value between any of the minimum and maximum values noted above.

According to still other embodiments, the calcium based filler component of the second component may include particular materials. For example, the calcium based filler component may include ground calcium carbonate. According to still other embodiments, the calcium based filler component may include synthesized calcium carbonate.

According to certain embodiments, the second component may include a particular content of calcium based filler component. For example, the second component may include a calcium based filler component content of at least about 5 wt. % for a total weight of the second component, such as at least about 6 wt. % or at least about 7 wt. % or at least about 8 wt. % or at least about 9 wt. % or even at least about 10 wt. %. According to still other embodiments, the second component may include a calcium based filler component content of not greater than about 15 wt. % for a total weight of the second component, such as not greater than about 14 wt. % or not greater than about 13 wt. % or not greater than about 12 wt. % or even not greater than about 11 wt. %. It will be appreciated that the content of the calcium based filler component in the second component may be within a range between any of the minimum and maximum values noted above. It will be further appreciated that the content of the calcium based filler component in the second component may be any value between any of the minimum and maximum values noted above.

According to yet other embodiments, the two-part forming mixture may have a particular skin time as measured by applying a strip of the two-part forming mixture onto a PET release liner under water in the petri dish, using a clean spatula to touch the sealant until there is no residue on the spatula, counting the time from extrusion of the two-part forming mixture to no adhesive on the spatula. For example, the two-part forming mixture may have a skin time of not greater than about 60 seconds, such as not greater than about 55 seconds or not greater than about 50 seconds or not greater than about 45 seconds or not greater than about 40 seconds or not greater than about 35 seconds or not greater than about 30 seconds or not greater than about 25 seconds or even not greater than about 20 seconds. According to still other embodiments, the two-part forming mixture may have a skin time of not greater than about 100 wt. %. It will be appreciated that the two-part forming mixture may have a skin time within a range between any of the minimum and maximum values noted above. It will be further appreciated that the two-part forming mixture may have a skin time of any value between any of the minimum and maximum values noted above.

Referring now to the silicone-based sealant formed according to embodiments described herein, the silicone-based sealant may include a particular content of silicone-based material. For example, the silicone-based sealant may include a silicone-based material content of at least about 55 wt. % for a total weight of the silicone-based sealant, such as, at least about 60 wt. % or at least about 65 wt. % or at least about 70 wt. % or at least about 75 wt. % or at least about 80 wt. % or at least about 85 wt. % or at least about 90 wt. % or at least about 95 wt. % or at least about 95.5 wt. % or at least about 96 wt. % or at least about 96.5 wt. % or at least about 97 wt. % or at least about 97.5 wt. % or at least about 98 wt. % or at least about 98.5 wt. % or at least about 99 wt. % or at least about 99.5 wt. % or at least about 99 wt. %. According to still other embodiments, the silicone-based sealant may consist entirely of a silicone-based material. It will be appreciated that the silicone-based sealant may include a silicone-based material content within a range between any of the minimum and maximum values noted above. It will be further appreciated that the silicone-based sealant may include a silicone-based material content of any value between any of the minimum and maximum values noted above.

According to still other embodiments, the two-part forming mixture may be configured to be dispensed from a dual chambered extrusion device into a combining nozzle and then onto a surface.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A silicone-based sealant formed from a two-part forming mixture, wherein the two-part forming mixture comprises a first component and a second component that chemically reacts with the first component upon combination, wherein the first component of the two-part forming mixture comprises: an amino silicone component, a filler composition, and a silane component; wherein the second component comprises; an aldehyde component.

Embodiment 2. A two-part forming mixture comprising a first component and a second component that chemically reacts with the first component upon combination to form a silicone-based sealant, wherein the first component of the two-part forming mixture comprises: an amino silicone component, a filler composition, and a silane component; wherein the second component comprises; an aldehyde component.

Embodiment 3. A method of forming a silicone-based sealant comprising providing a two-part forming mixture, wherein the two-part forming mixture comprises a first component and a second component, wherein the first component of the two-part forming mixture comprises: an amino silicone component, a filler composition, and a silane component; wherein the second component comprises; an aldehyde component; and combining the first component and the second component, wherein the second component chemically reacts with the first component to form the silicone-based sealant.

Embodiment 4. The silicone-based sealant, two-part forming mixture, or method of any one of embodiments 1, 2, and 3, wherein the second component chemically reacts with the first component by forming a gel and then curing the gel to form the silicone-based sealant.

Embodiment 5. The silicone-based sealant, two-part forming mixture, or method of any one of embodiments 1, 2, and 3, wherein forming the gel and then curing the gel can occur when submerged in water.

Embodiment 6. The silicone-based sealant, two-part forming mixture, or method of any one of embodiments 1, 2, and 3, wherein the two-part forming mixture comprises a first component content of at least about 60 wt. % for a total weight of the two-part forming mixture, or at least about 62 wt. % or at least about 64 wt. % or at least about 66 wt. % or at least about 68 wt. % or at least about 70 wt. % or at least about 72 wt. % or at least about 74 wt. % or at least about 76 wt. % or at least about 78 wt. % or at least about 80 wt. %.

Embodiment 7. The silicone-based sealant, two-part forming mixture, or method of any one of embodiments 1, 2, and 3, wherein the two-part forming mixture comprises a first component content of not greater than about 95 wt. % for a total weight of the two-part forming mixture or not greater than about 94 wt. % or not greater than about 93 wt. % or not greater than about 92 wt. % or not greater than about 91 wt. % or not greater than about 90 wt. % or not greater than about 89 wt. % or not greater than about 88 wt. % or not greater than about 87 wt. % or not greater than about 86 wt. % or not greater than about 85 wt. %.

Embodiment 8. The silicone-based sealant, two-part forming mixture, or method of any one of embodiments 1, 2, and 3, wherein the two-part forming mixture comprises a second component content of at least about 5 wt. % for a total weight of the two-part forming mixture or at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or at least about 15 wt. %.

Embodiment 9. The silicone-based sealant, two-part forming mixture, or method of any one of embodiments 1, 2, and 3, wherein the two-part forming mixture comprises a second component content of not greater than about 40 wt. % for a total weight of the two-part forming mixture, such as, not greater than about 38 wt. % or not greater than about 35 wt. % or not greater than about 32 wt. % or not greater than about 30 wt. % or not greater than about 28 wt. % or not greater than about 25 wt. % or not greater than about 22 wt. % or not greater than about 20 wt. %.

Embodiment 10. The silicone-based sealant, two-part forming mixture, or method of any one of embodiments 1, 2, and 3, wherein the first component has a viscosity of at least about 6,000 cps or at least about 6,500 cps or at least about 7,000 cps or at least about 7,500 cps or at least about 8,000 cps or at least about 8,500 cps or at least about 9,000 cps or even at least about 9,500 cps.

Embodiment 11. The silicone-based sealant, two-part forming mixture, or method of any one of embodiments 1, 2, and 3, wherein the first component has a viscosity of not greater than about 40,000 cps or not greater than about 38,000 cps or not greater than about 36,000 cps or not greater than about 34,000 cps or not greater than about 32,000 cps or not greater than about 30,000 cps or not greater than about 28,000 cps or even not greater than about 26,000 cps.

Embodiment 12. The silicone-based sealant, two-part forming mixture, or method of any one of embodiments 1, 2, and 3, wherein the second component has a viscosity of at least about 1,000 cps or at least about 1,500 cps or at least about 2,000 cps or at least about 2,500 cps or at least about 3,000 cps or at least about 3,500 cps.

Embodiment 13. The silicone-based sealant, two-part forming mixture, or method of any one of embodiments 1, 2, and 3, wherein the second component has a viscosity of not greater than about 20,000 cps or not greater than about 18,000 cps or not greater than about 16,000 cps or not greater than about 14,000 cps or not greater than about 12,000 cps.

Embodiment 14. The silicone-based sealant, two-part forming mixture, or method of any one of embodiments 1, 2, and 3, wherein the amino silicone component of the first component comprises aminopropyl-terminated polydimethylsiloxanes, aminopropylmethylsiloxane-dimethylsiloxane copolymers, aminocthylaminoproplymethoxysiloxane dimethylsiloxane copolymers with branch structures or any combination thereof.

Embodiment 15. The silicone-based sealant, two-part forming mixture, or method of any one of embodiments 1, 2, and 3, wherein the first component comprises an amino silicone component content of at least about 60 wt. % for a total weight of the first component or at least about 61 wt. % or at least about 62 wt. % or at least about 63 wt. % or at least about 64 wt. % or at least about 65 wt. % or at least about 66 wt. % or at least about 67 wt. % or at least about 68 wt. % or at least about 69 wt. % or at least about 70 wt. %.

Embodiment 16. The silicone-based sealant, two-part forming mixture, or method of any one of embodiments 1, 2, and 3, wherein the first component comprises an amino silicone component content of not greater than about 80 wt. % for a total weight of the first component or not greater than about 79 wt. % or not greater than about 78 wt. % or not greater than about 77 wt. % or not greater than about 76 wt. % or not greater than about 75 wt. % or not greater than about 74 wt. % or not greater than about 73 wt. % or not greater than about 72 wt. % or not greater than about 71 wt. %.

Embodiment 17. The silicone-based sealant, two-part forming mixture, or method of any one of embodiments 1, 2, and 3, wherein the amino silicone component of the first component has a viscosity of at least about 10 cps or at least about 25 cps or at least about 50 cps or at least about 75 cps or at least about 100 cps or at least about 200 cps or at least about 300 cps or at least about 400 cps.

Embodiment 18. The silicone-based sealant, two-part forming mixture, or method of any one of embodiments 1, 2, and 3, wherein the amino silicone component of the first component has a viscosity of not greater than about 6,000 cps or not greater than about 5,500 cps or not greater than about 5,000 cps or not greater than about 4,500 cps or not greater than about 4,000 cps or not greater than about 3,500 cps or not greater than about 3,000 cps.

Embodiment 19. The silicone-based sealant, two-part forming mixture, or method of any one of embodiments 1, 2, and 3, wherein the amino silicone component has a pendant amino position.

Embodiment 20. The silicone-based sealant, two-part forming mixture, or method of any one of embodiments 1, 2, and 3, wherein the amino silicone component has a terminal amino position.

Embodiment 21. The silicone-based sealant, two-part forming mixture, or method of any one of embodiments 1, 2, and 3, wherein the amino silicone component comprises an amino content of at least about 0.05 wt. % for a total weight of the amino silicone component.

Embodiment 22. The silicone-based sealant, two-part forming mixture, or method of any one of embodiments 1, 2, and 3, wherein the amino silicone component comprises an amino content of not greater than about 25 wt. % for a total weight of the amino silicone component.

Embodiment 23. The silicone-based sealant, two-part forming mixture, or method of any one of embodiments 1, 2, and 3, wherein the amino silicone component of the first component comprises a short chain amino silicone and a long chain amino silicone.

Embodiment 24. The silicone-based sealant, two-part forming mixture, or method of embodiment 23, wherein the short chain amino silicone comprises aminopropyl-terminated polydimethylsiloxanes, aminopropylmethylsiloxane-dimethylsiloxane copolymers, aminoethylaminoproplymethoxysiloxane dimethylsiloxane copolymers with branch structures or any combination thereof.

Embodiment 25. The silicone-based sealant, two-part forming mixture, or method of embodiment 23, wherein the first component comprises a short chain amino silicone component content of at least about 40 wt. % for a total weight of the first component or at least about 41 wt. % or at least about 42 wt. % or at least about 43 wt. % or at least about 44 wt. % or at least about 45 wt. % or at least about 46 wt. % or at least about 47 wt. % or at least about 48 wt. % or at least about 49 wt. % or at least about 50 wt. %.

Embodiment 26. The silicone-based sealant, two-part forming mixture, or method of embodiment 23, wherein the first component comprises a short chain amino silicone component content of not greater than about 60 wt. % for a total weight of the first component or not greater than about 59 wt. % or not greater than about 58 wt. % or not greater than about 57 wt. % or not greater than about 56 wt. % or not greater than about 55 wt. % or not greater than about 54 wt. % or not greater than about 53 wt. % or not greater than about 52 wt. % or not greater than about 51 wt. %.

Embodiment 27. The silicone-based sealant, two-part forming mixture, or method of embodiment 23, wherein the short chain amino silicone has a viscosity of at least about 10 cps or at least about 25 cps or at least about 50 cps or at least about 75 cps or at least about 100 cps or at least about 200 cps or at least about 300 cps or at least about 400 cps.

Embodiment 28. The silicone-based sealant, two-part forming mixture, or method of embodiment 23, wherein the short chain amino silicone has a viscosity of not greater than about 800 cps or as not greater than about 775 cps or not greater than about 750 cps or not greater than about 725 cps or not greater than about 700 cps or not greater than about 675 cps or not greater than about 650 cps or not greater than about 625 cps or not greater than about 600 cps.

Embodiment 29. The silicone-based sealant, two-part forming mixture, or method of any one of embodiments 1, 2, and 3, wherein the short chain amino silicone has a pendant amino position.

Embodiment 30. The silicone-based sealant, two-part forming mixture, or method of any one of embodiments 1, 2, and 3, wherein the short chain amino silicone has a terminal amino position.

Embodiment 31. The silicone-based sealant, two-part forming mixture, or method of any one of embodiments 1, 2, and 3, wherein the short chain amino silicone comprises an amino content of at least about 2.0 wt. % for a total weight of the short chain amino silicone.

Embodiment 32. The silicone-based sealant, two-part forming mixture, or method of any one of embodiments 1, 2, and 3, wherein the short chain amino silicone comprises an amino content of not greater than about 25.0 wt. % for a total weight of the short chain amino silicone.

Embodiment 33. The silicone-based sealant, two-part forming mixture, or method of embodiment 23, wherein the long chain amino silicone comprises aminopropyl-terminated polydimethylsiloxanes, aminopropylmethylsiloxane-dimethylsiloxane copolymers, aminoethylaminoproplymethoxysiloxane dimethylsiloxane copolymers with branch structures or any combination thereof.

Embodiment 34. The silicone-based sealant, two-part forming mixture, or method of embodiment 23, wherein the first component comprises a long chain amino silicone component content of at least about 10 wt. % for a total weight of the first component or at least about 11 wt. % or at least about 12 wt. % or at least about 13 wt. % or at least about 14 wt. % or at least about 15 wt. %.

Embodiment 35. The silicone-based sealant, two-part forming mixture, or method of embodiment 23, wherein the first component comprises a long chain amino silicone component content of not greater than about 20 wt. % for a total weight of the first component or not greater than about 19 wt. % or not greater than about 18 wt. % or not greater than about 17 wt. % or not greater than about 16 wt. %.

Embodiment 36. The silicone-based sealant, two-part forming mixture, or method of embodiment 23, wherein the long chain amino silicone has a viscosity of at least about 800 cps.

Embodiment 37. The silicone-based sealant, two-part forming mixture, or method of embodiment 23, wherein the long chain amino silicone has a viscosity of not greater than about 6,000 cps.

Embodiment 38. The silicone-based sealant, two-part forming mixture, or method of any one of embodiments 1, 2, and 3, wherein the long chain amino silicone has a pendant amino position.

Embodiment 39. The silicone-based sealant, two-part forming mixture, or method of any one of embodiments 1, 2, and 3, wherein the long chain amino silicone has a terminal amino position.

Embodiment 40. The silicone-based sealant, two-part forming mixture, or method of any one of embodiments 1, 2, and 3, wherein the long chain amino silicone comprises an amino content of at least about 0.05 wt. % for a total weight of the long chain amino silicone.

Embodiment 41. The silicone-based sealant, two-part forming mixture, or method of any one of embodiments 1, 2, and 3, wherein the long chain amino silicone comprises an amino content of not greater than about 0.15 wt. % for a total weight of the long chain amino silicone.

Embodiment 42. The silicone-based sealant, two-part forming mixture, or method of any one of embodiments 1, 2, and 3, wherein the filler composition of the first component comprises silica. According to still other embodiments, the filler composition of the first component may include fumed silica. According to still other embodiments, the filler composition of the first component may include precipitate silica. According to still other embodiments, the filler composition of the first component may include silicates, such as mica, or wollastonite. According to still other embodiments, the filler composition of the first component may include metal oxides, such as aluminum oxide, titanium dioxide, magnesium oxide, ferric oxide, beryllium oxide, chromium oxide, or zinc oxide. According to still other embodiments, the filler composition of the first component may include metal carbonates, such as calcium carbonate.

Embodiment 43. The silicone-based sealant, two-part forming mixture, or method of any one of embodiments 1, 2, and 3, wherein the first component comprises a filler composition content of at least about 25 wt. % for a total weight of the first component or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or at least about 35 wt. %.

Embodiment 44. The silicone-based sealant, two-part forming mixture, or method of any one of embodiments 1, 2, and 3, wherein the first component comprises a filler composition content of not greater than about 45 wt. % for a total weight of the first component or not greater than about 44 wt. % or not greater than about 43 wt. % or not greater than about 42 wt. % or not greater than about 41 wt. % or not greater than about 40 wt. % or not greater than about 39 wt. % or not greater than about 38 wt. % or not greater than about 37 wt. % or not greater than about 36 wt. %.

Embodiment 45. The silicone-based sealant, two-part forming mixture, or method of any one of embodiments 1, 2, and 3, wherein the filler composition of the first component comprises a silica based filler component and a calcium based filler component.

Embodiment 46. The silicone-based sealant, two-part forming mixture, or method of embodiment 45, wherein the silica based filler component comprises natural silica, such as crystalline silica, ground crystalline silica, or diatomaceous silica. According to still other embodiments, the silica based filler component may include synthetic silica, such as fused silica, silica gel, pyrogenic silica, or precipitated silica.

Embodiment 47. The silicone-based sealant, two-part forming mixture, or method of embodiment 45, wherein the first component comprises a silica based filler component content of at least about 15 wt. % for a total weight of the first component or at least about 16 wt. % or at least about 17 wt. % or at least about 18 wt. % or at least about 19 wt. % or at least about 20 wt. % or at least about 21 wt. % or at least about 22 wt. % or at least about 23 wt. % or at least about 24 wt. % or at least about 25 wt. %.

Embodiment 48. The silicone-based sealant, two-part forming mixture, or method of embodiment 45, wherein the first component comprises a silica based filler component content of not greater than about 35 wt. % for a total weight of the first component or not greater than about 34 wt. % or not greater than about 33 wt. % or not greater than about 32 wt. % or not greater than about 31 wt. % or not greater than about 30 wt. % or not greater than about 29 wt. % or not greater than about 28 wt. % or not greater than about 27 wt. % or not greater than about 26 wt. %.

Embodiment 49. The silicone-based sealant, two-part forming mixture, or method of embodiment 45, wherein the calcium based filler component comprises ground calcium carbonate. According to still other embodiments, the calcium based filler component may include synthesized calcium carbonate.

Embodiment 50. The silicone-based sealant, two-part forming mixture, or method of embodiment 45, wherein the first component comprises a calcium based filler component content of at least about 5 wt. % for a total weight of the first component or at least about 6 wt. % or at least about 7 wt. % or at least about 8 wt. % or at least about 9 wt. % or at least about 10 wt. %.

Embodiment 51. The silicone-based sealant, two-part forming mixture, or method of embodiment 45, wherein the first component comprises a calcium based filler component content of not greater than about 15 wt. % for a total weight of the first component or not greater than about 14 wt. % or not greater than about 13 wt. % or not greater than about 12 wt. % or not greater than about 11 wt. %.

Embodiment 52. The silicone-based sealant, two-part forming mixture, or method of any one of embodiments 1, 2, and 3, wherein the silane component of the first component comprises octyltrimethoxysilane, 3-Glycidyloxypropyl(dimethoxy)-methylsilane, 3-Glycidyloxypropyltrimethoxysilane, Diethoxy(3-glycidyloxypropyl)-methylsilane, Triethoxy(3-glycidyloxypropyl)-silane, [8-(Glycidyloxy)-n-octyl]-trimethoxysilane, methacryloxypropyl trimethoxysilane, vinyl trimethoxysilane, tetraethoxysilane, 3-Aminopropyltrimethoxysilane, 3-Aminopropyldimethoxymethylsilane, 3-Aminopropyldiethoxymethylsilane, 3-Aminopropyltriethoxysilane, 3-(2-Aminoethylamino)-propyldimethoxymethylsilane, 3-(2-Aminoethylamino)-propyltrimethoxysilane, 3-(2-Aminoethylamino)-propyltriethoxysilane, [3-(6-Aminohexylamino)-propyl]trimethoxysilane, Trimethoxy[3-(phenylamino)-propyl]silane, Bis[3-(trimethoxysilyl)-propyl]amine, partial condensation products thereof, or any combination thereof.

Embodiment 53. The silicone-based sealant, two-part forming mixture, or method of any one of embodiments 1, 2, and 3, wherein the first component comprises a silane component content of at least about 0.5 wt. % for a total weight of the first component or at least about 0.6 wt. % or at least about 0.7 wt. % or at least about 0.8 wt. % or at least about 0.9 wt. % or at least about 1.0 wt. %.

Embodiment 54. The silicone-based sealant, two-part forming mixture, or method of any one of embodiments 1, 2, and 3, wherein the first component comprises a silane component content of not greater than about 1.5 wt. % for a total weight of the first component or not greater than about 1.4 wt. % or not greater than about 1.3 wt. % or not greater than about 1.2 wt. % or not greater than about 1.1 wt. %.

Embodiment 55. The silicone-based sealant, two-part forming mixture, or method of any one of embodiments 1, 2, and 3, wherein the aldehyde component of the second component comprises adipaldehyde, glutaraldehyde, oxaldehyde, formaldehyde, butanedial, 2,5-Thiophenedicarboxaldehyde, terephthalaldehyde, or any combination thereof.

Embodiment 56. The silicone-based sealant, two-part forming mixture, or method of any one of embodiments 1, 2, and 3, wherein the first component comprises an aldehyde component content of at least about 5 wt. % for a total weight of the second component or at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or at least about 15 wt. %.

Embodiment 57. The silicone-based sealant, two-part forming mixture, or method of any one of embodiments 1, 2, and 3, wherein the second component comprises an aldehyde component content of not greater than about 50 wt. % for a total weight of the second component or not greater than about 48 wt. % or not greater than about 45 wt. % or not greater than about 43 wt. % or not greater than about 40 wt. % or not greater than about 38 wt. % or not greater than about 35 wt. % or not greater than about 33 wt. % or not greater than about 30 wt. % or even not greater than about 25 wt. %.

Embodiment 58. The silicone-based sealant, two-part forming mixture, or method of any one of embodiments 1, 2, and 3, wherein the two-part forming mixture has a skin time of not greater than about 60 seconds or not greater than about 55 seconds or not greater than about 50 seconds or not greater than about 45 seconds or not greater than about 40 seconds or not greater than about 35 seconds or not greater than about 30 seconds or not greater than about 25 seconds or not greater than about 20 seconds.

Embodiment 59. The silicone-based sealant, two-part forming mixture, or method of any one of embodiments 1, 2, and 3, wherein the two-part forming mixture is configured to be dispensed from a dual chambered extrusion device into a combining nozzle and then onto a surface.

Embodiment 60. The silicone-based sealant, two-part forming mixture, or method of any one of embodiments 1, 2, and 3, wherein the second component further comprises a filler composition.

Embodiment 61. The silicone-based sealant, two-part forming mixture, or method of embodiments 60, wherein the filler composition of the second component comprises silica, fumed silica, precipitate silica, silicates, mica, wollastonite, metal oxides, aluminum oxide, titanium dioxide, magnesium oxide, ferric oxide, beryllium oxide, chromium oxide, or zinc oxide, metal carbonates, or calcium carbonate.

Embodiment 62. The silicone-based sealant, two-part forming mixture, or method of embodiments 60, wherein the second component comprises a filler composition content of at least about 5 wt. % for a total weight of the second component, such as at least about 6 wt. % or at least about 7 wt. % or at least about 8 wt. % or at least about 9 wt. % or at least about 10 wt. % or at least about 11 wt. % or at least about 12 wt. % or at least about 13 wt. % or at least about 14 wt. % or even at least about 15 wt. %.

Embodiment 63. The silicone-based sealant, two-part forming mixture, or method of embodiments 60, wherein the second component comprises a filler composition content of not greater than about 50 wt. % for a total weight of the second component, such as not greater than about 48 wt. % or not greater than about 45 wt. % or not greater than about 43 wt. % or not greater than about 40 wt. % or not greater than about 38 wt. % or not greater than about 35 wt. % or not greater than about 33 wt. % or not greater than about 30 wt. % or even not greater than about 25 wt. %.

Embodiment 64. The silicone-based sealant, two-part forming mixture, or method of embodiments 60, wherein the filler composition of the second component comprises a silica based filler composition and a calcium based filler composition.

Embodiment 65. The silicone-based sealant, two-part forming mixture, or method of embodiment 64, wherein the silica based filler composition comprises natural silica, such as crystalline silica, ground crystalline silica, or diatomaceous silica. According to still other embodiments, the silica based filler composition may include synthetic silica, such as fused silica, silica gel, pyrogenic silica, or precipitated silica.

Embodiment 66. The silicone-based sealant, two-part forming mixture, or method of embodiment 64, wherein the second component comprises a silica based filler composition content of at least about 15 wt. % for a total weight of the second component or at least about 16 wt. % or at least about 17 wt. % or at least about 18 wt. % or at least about 19 wt. % or at least about 20 wt. % or at least about 21 wt. % or at least about 22 wt. % or at least about 23 wt. % or at least about 24 wt. % or at least about 25 wt. %.

Embodiment 67. The silicone-based sealant, two-part forming mixture, or method of embodiment 64, wherein the second component comprises a silica based filler composition content of not greater than about 35 wt. % for a total weight of the second component or not greater than about 34 wt. % or not greater than about 33 wt. % or not greater than about 32 wt. % or not greater than about 31 wt. % or not greater than about 30 wt. % or not greater than about 29 wt. % or not greater than about 28 wt. % or not greater than about 27 wt. % or not greater than about 26 wt. %.

Embodiment 689. The silicone-based sealant, two-part forming mixture, or method of embodiment 64, wherein the calcium based filler composition comprises ground calcium carbonate. According to still other embodiments, the calcium based filler composition may include synthesized calcium carbonate.

Embodiment 69. The silicone-based sealant, two-part forming mixture, or method of embodiment 64, wherein the second component comprises a calcium filler composition content of at least about 5 wt. % for a total weight of the second component or at least about 6 wt. % or at least about 7 wt. % or at least about 8 wt. % or at least about 9 wt. % or at least about 10 wt. %.

Embodiment 70. The silicone-based sealant, two-part forming mixture, or method of embodiment 45, wherein the second component comprises a calcium based filler composition content of not greater than about 15 wt. % for a total weight of the second component or not greater than about 14 wt. % or not greater than about 13 wt. % or not greater than about 12 wt. % or not greater than about 11 wt. %.

### EXAMPLE

### Example 1

A representative two-part forming mixture Sample S1 is utilized to form a sealant Sample S2. The composition of Sample S1 is noted in Table 1 below.

Sample S1 is prepared as follows. An initial mixture of aminopropyl-terminated polydimethylsiloxanes and octyltrimethoxysilane is made using SpeedMixer® (from FlackTek) at 3000 RPM for 1 min. Fumed silica and calcium carbonate are then added, and the mixture is mixed for another minute at the same speed to form the first component of Sample S1. If a double-barrel cartridge (10:1 ratio) is used, the first component is transferred to the large barrel and the second component, formalin solution (8 wt. %), is added to the small barrel. The cartridge is loaded on the extruding gun and the mixture of Sample S1 is extruded on a PET release liner that is submerged underwater.

If a single barrel is used, after the first component is added, air is removed from the barrel, and then the barrel is capped. Formalin solution is then added through the extrusion hole. A static mixing tip is then attached, and the mixture is extruded on a PET release liner that is submerged underwater.

Sample S1 is submerged, and the skin time is approximately 15 sec.

TABLE 1

| Part | Component | Content (wt. %) |
|---|---|---|
| 1^{st} component | aminopropyl-terminated | 60.7 |
| | polydimethylsiloxanes | |
| | octyltrimethoxysilane | 1.0 |
| | fumed silica | 21.0 |
| | calcium carbonate | 9.3 |
| 2^{nd} component | Formalin | 8 |

Sealant Sample S2 is released from the liner for property tests included in Table 2 below. Hardness is determined using the portable shore A and shore 00 durometer according to ASTM D2240. Elongation-at-break is tested using Instron® tensile tester according to ASTM D638. Tear strength is tested using Instron® tensile tester according to ASTM D624. Lap shear strength is tested using Instron® tensile tester according to ASTM D906 and ASTM D1002.

Another sealant sample S2 is formed to seal a leakage of a water container. The first component of Sample S1 is prepared as described above. A double-barrel cartridge is used. The extruding gun is extended under water and the mixture is extruded to cover a hole of the container. The mixture gelled in 15 seconds and leakage of water is stopped.

TABLE 2

| | |
|---|---|
| Hardness (SHA) | 14 |
| Hardness (SH00) | 63 |
| Tensile strength (MPa) | 0.48 ± 0.065 |
| Elongation (%) | 231.2 ± 15 |
| Tear Strength (N/mm) | 0.67 ± 0.12 |
| Lap Shear strength (Wood, Pa) | 74 ± 1.4 |
| Lap Shear strength (Aluminum, Pa) | 29 ± 1.3 |

### Example 2

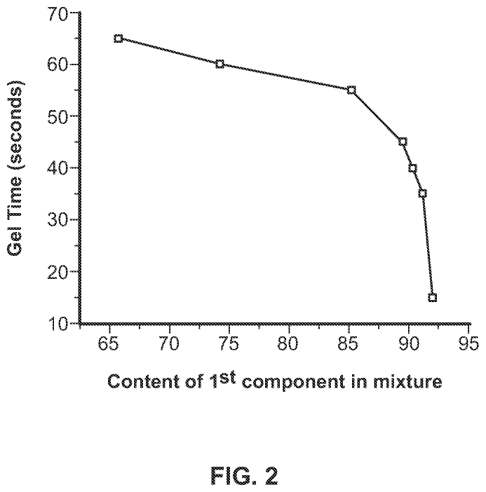

Gel time is tested on 2-part forming mixture samples including different contents of the first component. The first component is prepared in the same manner and has the same composition as described with respect to Sample S1. The first component is mixed with formalin solution at different weight ratios so that the final mixtures include approximately 65 wt. %, 74 wt. %, 85 wt. %, 87 wt. %, 90 wt. %, 91 wt. %, and 92 wt. % of the first component relative to the total weight of the respective mixtures. Gel formation is examined as described in embodiments herein with respect to skin time. As illustrated in FIG. 2, mixtures including higher contents of the first component tend to gel faster. The critical point of the content is approximately 85 wt. % with respect to gel time, and the corresponding gel time is approximately 55 seconds. Sixty seconds of gel time is considered the threshold for underwater curing. A 2-part forming mixture having the skin time over 60 seconds is not expected to cure properly underwater and is not expected to form a functional sealant underwater.

### Example 3

Two-part forming mixture samples are prepared, and skin time is tested on the mixtures. The mixtures are prepared in the same manner as described with respect to Sample S1. The compositions of the samples are noted in Tables 3-7 below.

TABLE 3

| Two-part forming mixture | | |
|---|---|---|
| S4 | Component | Content (wt. %) |
| 1^{st} component | aminopropyl-terminated | 27.3 |
| | polydimethylsiloxanes | |
| | octyltrimethoxysilane | 1.0 |
| | fumed silica | 44.1 |
| | calcium carbonate | 19.6 |
| 2^{nd} component | Formalin | 8 |

TABLE 4

| Two-part forming mixture | | |
|---|---|---|
| S5 | Component | Content (wt. %) |
| 1^{st} component | aminopropyl-terminated | 45.5 |
| | polydimethylsiloxanes | |
| | octyltrimethoxysilane | 1.0 |
| | fumed silica | 31.5 |
| | calcium carbonate | 14.0 |
| 2^{nd} component | formalin | 8 |

TABLE 5

| Two-part forming mixture | | |
|---|---|---|
| S6 | Component | Content (wt. %) |
| 1^{st} component | aminopropyl-terminated | 60.6 |
| | polydimethylsiloxanes | |
| | octyltrimethoxysilane | 1.0 |
| | fumed silica | 21.1 |
| | calcium carbonate | 9.4 |
| 2^{nd} component | formalin | 8 |

TABLE 6

| Two-part forming mixture | | |
|---|---|---|
| S7 | Component | Content (wt. %) |
| 1^{st} component | aminopropyl-terminated | 72.9 |
| | polydimethylsiloxanes | |
| | octyltrimethoxysilane | 1.0 |
| | fumed silica | 12.6 |
| | calcium carbonate | 5.6 |
| 2^{nd} component | formalin | 8 |

TABLE 7

| Two-part forming mixture | | |
|---|---|---|
| S8 | Component | Content (wt. %) |
| 1^{st} component | aminopropyl-terminated | 82.0 |
| | polydimethylsiloxanes | |
| | octyltrimethoxysilane | 1.0 |
| | fumed silica | 6.3 |
| | calcium carbonate | 2.8 |
| 2^{nd} component | formalin | 8 |

The contents of the amino silicone component of the samples are noted in Table 8. Skin times for the samples are determined as described in embodiments herein. The viscosities are tested on the first components of the samples by using a rheometer (TA Instrument HR-30) with a 25-mm parallel plate. The frequency sweep is performed by ranging the frequency from 0.01 s⁻¹ to 100 s⁻¹. Skin time of the mixtures and viscosities for the first components are included in Table 8.

TABLE 8

| | Amino silicone | | | |
|---|---|---|---|---|
| | component | | | |
| Two-part | (wt. % relative to | | Viscosities | Viscosities |
| forming | the total weight | Skin | of the first | of the first |
| mixture | of the first | time | components at | components at |
| Samples | component) | (s) | 0.01 s⁻¹ (Pa · s) | 1 s⁻¹ (Pa · s) |
| S4 | 30 | — | N/A | N/A |
| S5 | 50 | 60 | 8395.4 | 2020.0 |
| S6 | 65 | 15 | 427.8 | 52.3 |
| S7 | 80 | 15 | 36.4 | 5.1 |
| S8 | 90 | 15 | 2.6 | 0.88 |

It can be observed that skin time decreases with increases of the contents of the amino silicone component. Gelation is not detected in the mixture having 30 wt. % of the amino silicone component for the total weight of the first component. Skin time is approximately 60 seconds for the mixture having 50 wt. % of the amino silicone component for the total weight of the first component. Samples S6 to S8 demonstrated similar gel time, approximately 15 seconds, which is significantly faster compared to Sample S5.

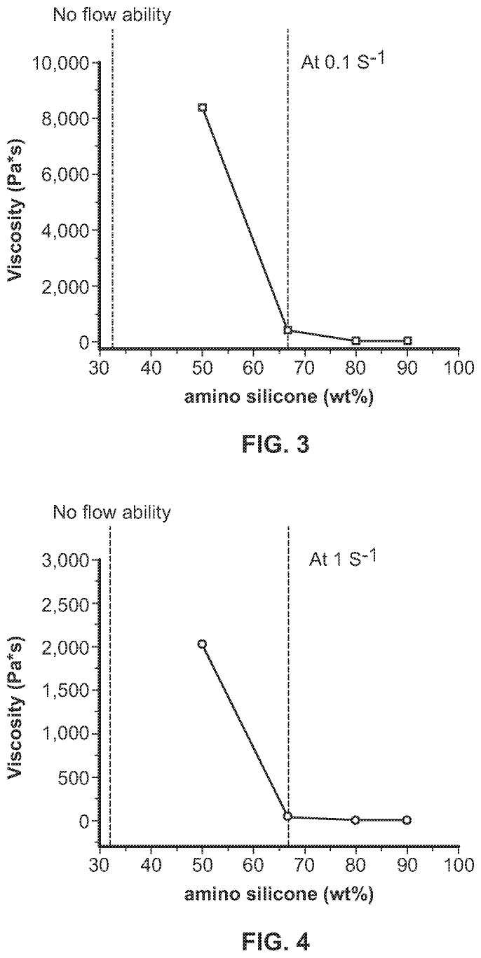

As illustrated in FIGS. 3-4, the viscosities of the first components decrease when the contents of the amino silicone component increase. The first component of Sample S4 does not demonstrate detectable flowability at both frequencies, and caking issues are observed when forming the first component of Sample S4. The first component of Sample S5 demonstrates detectable viscosities but it is difficult to form a uniform mixture of the first and second components of Sample 5. The first components of Samples S5-S8 demonstrate viscosities from approximately 8400 Pa·s to 2.6 Pa·s at 0.1 s⁻¹ (FIG. 3). When the frequency is 1 s⁻¹ (FIG. 4), the viscosities are from approximately 2020.0 Pa·s to 0.88 Pa·s for the first components of Samples S5 to S8. Further, a significant decrease in viscosity is observed at both frequencies when the content of the amino silicone component is increased to approximately 65 wt. %, which suggests 65 wt. % is the critical point of the content of the amino silicone component with respect to viscosity. The first components of Samples S6 to S8 demonstrate viscosities from 427 Pa·s to 2.6 Pa·s at 0.1 s⁻¹ and 52.3 Pa·s to 0.88 Pa·s at 1 s⁻¹.

### Example 4

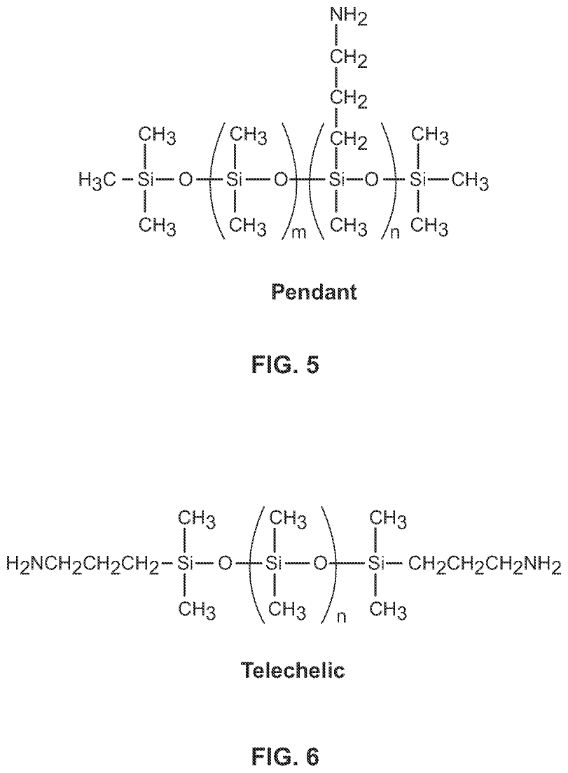

Skin time is tested on mixtures including different amino silicones as noted in Table 9 below. Formulas of telechelic and pendant amino silicones are illustrated in FIGS. 5 and 6, respectively.

TABLE 9

| | | Mole ratio of | |
|---|---|---|---|
| | Molecular | aldehyde to | |
| Amino silicone | weight (g/mol) | amine | Skin time (sec) |
| Telechelic | 3000 | 1:4 | 20 |
| Telechelic | 3000 | 3:4 | 30 |
| Telechelic | 25000 | 1:4 | 120 |
| Pendant | 8500 | 1:2 | 20 |
| Pendant | 8500 | 1:1 | 35 |
| Pendant | 20000 | 1:2 | 5 |
| Pendant | 20000 | 1:1 | 10 |

### Example 5

Additional sealant Samples S20-S22 are made using 2-part forming mixtures S10-S12, respectively. Compositions of the mixtures are included in Tables 5-7 below and prepared in the same manner as described with respect to Sample S1. The mixtures are expected to cure in approximately 2 min when submerged. Properties of the sealant Samples S20-S22 are to be tested and expected to be satisfactory. Properties to be tested include those noted in Table 2.

TABLE 10

| Part of Sample S5 | Component | Content (wt. %) |
|---|---|---|
| 1^{st} part | Pendant amino silicone, 8500 | 73.5 |
| | g/mol | |
| | Epoxy silane and amino silane | 1 |
| | fumed silica | 24.5 |
| 2^{nd} part | Formalin (8 wt. %) | 1 |

TABLE 11

| Part of Sample S5 | Component | Content (wt. %) |
|---|---|---|
| 1^{st} part | Pendant amino silicone, 20000 | 44 |
| | g/mol | |
| | Pendant amino silicone, 25000 | 44 |
| | g/mol | |
| | Epoxy silane and amino silane | 1 |
| | fumed silica | 10 |
| 2^{nd} part | formalin (8 wt. %) | 1 |

TABLE 12

| Part of Sample S5 | Component | Content (wt. %) |
|---|---|---|
| 1^{st} part | Telechelic amino silicone, 3000 | 51.8 |
| | g/mol | |
| | Telechelic amino silicone, 25000 | 14.2 |
| | g/mol | |
| | fumed silica | 10.2 |
| | Calcium carbonate | 22.8 |
| | Epoxy silane and amino silane | 1 |
| 2^{nd} part | formalin(8 wt. %) | 1 |

### Example 6

A sealant is formed under water using the 2-part formulation in Table 13.

TABLE 13

| Part | Component | Content (wt. %) |
|---|---|---|
| 1^{st} component | Telechelic amino silicone, 3000 | 51.8 |
| | g/mol | |
| | Telechelic amino silicone, 25000 | 14.2 |
| | g/mol | |
| | fumed silica | 22.8 |
| | Calcium carbonate | 10.2 |
| | Epoxy silane and amino silane | 1 |
| 2^{nd} component | formalin | 1 |

The first component and the mixture of the first and second components is prepared in the similar manner as described with respect to Sample S1. The mixture is extruded on a PET release liner that is submerged. The mixture demonstrates the gel time of about 20 seconds and cures in about 2 min.

Note that not all of the activities described above in the general description, or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A silicone-based sealant formed from a two-part forming mixture,
wherein the two-part forming mixture comprises a first component and a second component that chemically reacts with the first component upon combination,
wherein the first component of the two-part forming mixture comprises:
an amino silicone component
a filler composition, and
a silane component;
wherein the second component comprises;
an aldehyde component.

2. The silicone-based sealant of claim 1, wherein the two-part forming mixture comprises a first component content of at least about 60 wt. % and not greater than about 95 wt. % for a total weight of the two-part forming mixture.

3. The silicone-based sealant of claim 1, wherein the two-part forming mixture comprises a second component content of at least about 5 wt. % and not greater than about 40 wt. % for a total weight of the two-part forming mixture.

4. The silicone-based sealant of claim 1, wherein the first component has a viscosity of at least about 6,000 cps and not greater than about 40,000 cps.

5. The silicone-based sealant of claim 1, wherein the amino silicone component of the first component comprises aminopropyl-terminated polydimethylsiloxanes, aminopropylmethylsiloxane-dimethylsiloxane copolymers, aminoethylaminoproplymethoxysiloxane dimethylsiloxane copolymers with branch structures or any combination thereof.

6. The silicone-based sealant of claim 1, wherein the first component comprises an amino silicone component content of at least about 60 wt. % and not greater than about 80 wt. % for a total weight of the first component.

7. The silicone-based sealant of claim 6, wherein the amino silicone component has a pendant amino position.

8. The silicone-based sealant of claim 6, wherein the amino silicone component has a terminal amino position.

9. A two-part forming mixture, comprising a first component and a second component that chemically reacts with the first component upon combination to form a silicone-based sealant,
wherein the first component of the two-part forming mixture comprises:
an amino silicone component
a filler composition, and
a silane component;
wherein the second component comprises;
an aldehyde component.

10. The two-part forming mixture of claim 9, wherein the second component chemically reacts with the first component by forming a gel and then curing the gel to form the silicone-based sealant.

11. The two-part forming mixture of claim 9, wherein the two-part forming mixture comprises a first component content of at least about 60 wt. % and not greater than about 95 wt. % for a total weight of the two-part forming mixture.

12. The two-part forming mixture of claim 9, wherein the amino silicone component of the first component comprises aminopropyl-terminated polydimethylsiloxanes, aminopropylmethylsiloxane-dimethylsiloxane copolymers, aminoethylaminoproplymethoxysiloxane dimethylsiloxane copolymers with branch structures or any combination thereof.

13. The two-part forming mixture of claim 9, wherein the first component comprises an amino silicone component content of at least about 60 wt. % for a total weight of the first component.

14. The silicone-based sealant of claim 9, wherein the two-part forming mixture comprises a second component content of at least about 5 wt. % and not greater than about 40 wt. % for a total weight of the two-part forming mixture.

15. The silicone-based sealant of claim 9, wherein the first component has a viscosity of at least about 6,000 cps and not greater than about 40,000 cps.

16. A method of forming a silicone-based sealant comprising
providing a two-part forming mixture,
wherein the two-part forming mixture comprises a first component and a second component,
wherein the first component of the two-part forming mixture comprises:
an amino silicone component;
a filler composition, and
a silane component;
wherein the second component comprises;
an aldehyde component; and
combining the first component and the second component, wherein the second component chemically reacts with the first component to form the silicone-based sealant.

17. The method of claim 16, wherein the two-part forming mixture comprises a first component content of at least about 60 wt. %, and wherein the amino silicone component content is at least about 60 wt. % for a total weight of the first component.

18. The method of claim 16, wherein the two-part forming mixture comprises a second component content of at least about 5 wt. % and not greater than about 40 wt. % for a total weight of the two-part forming mixture.

19. The method of claim 16, wherein the first component has a viscosity of at least about 6,000 cps and not greater than about 40,000 cps.

20. The method of claim 16, wherein the two-part forming mixture has a skin time of at most 50 seconds.
